(19) United States
(12) Patent Application Publication
(10) Pub. No.: US 2013/0166565 A1
(43) Pub. Date: Jun. 27, 2013

(54) INTEREST BASED SOCIAL NETWORK SYSTEM

(71) Applicant: Kevin LEPSOE, Causeway Bay (HK)

(72) Inventor: Kevin LEPSOE, Causeway Bay (HK)

(21) Appl. No.: 13/725,079

(22) Filed: Dec. 21, 2012

Related U.S. Application Data
(60) Provisional application No. 61/579,868, filed on Dec. 23, 2011.

(51) Int. Cl. G06F 17/30

(52) U.S. Cl. CPC G06F 17/30713
USPC 707/740

(57) ABSTRACT

A system and method provide an interest based social network defined by a community of users who share the same topic interests. The methods and systems provide a collection of webpages based on a category of topics. Users may generate notes and ratings for each topic, which are then displayed on and integrated into the topic webpage. Users may also relate different topics, such that related topics will be provided in user searches of the topics. The method and system includes a category of topics hierarchy, with each topic being associated with a plurality of categories and sub-topics. The method and system additionally allow mapping of user comments and notes into the interest based social network from external social networks, and mapping of user comments and notes from the interest based social network to external social networks.

### RELATED APPLICATIONS

This application claims priority to U.S. provisional application 61/579,868, filed on Dec. 23, 2011, which is incorporated herein in its entirety.

### BACKGROUND OF THE INVENTION

The present invention relates to an interest based social network system providing a collection of web pages based on topic categories. The social network system provides both the topics of interest along with associated user generated notes, which can be either generated directly on the topic page or can be mapped from external social networks into the category of topics or topic page of the present invention.

### SUMMARY OF THE INVENTION

The present invention relates to an interest based social network system defined by a community of users who share the same topics of social interests. The present invention provides an ever evolving collection of web pages based on several categories of topics, along with associated user generated notes associated to each topic that has been created, rated, and organized by users. The present invention provides a web-based application where users can “create and discover” a constant cache for the user generated notes regarding any particular topic of social interest. Each topic webpage in the present invention becomes a reusable resource that will help any user who shares the same topic of social interest to further investigate and discover new knowledge, as opposed to leading to something already known.

Almost any topic web page in the social network system can be edited by any user who wishes to contribute to it. Users of the social network system keep it organized by creating additional details around each topic web page, as well as by linking related topics. The interest based social network system of the present invention relies on the good faith of everyone using it to make high quality contributions based on genuine interest in a particular topic of social interest.

There are several ways in which users of the present invention can “create, contribute, and discover” topics of social interests. Users have the ability to create their own notes, anytime they think a particular topic web page could become a better resource with more information added to it. Users have the ability create their own topics of social interests anytime a topic does not exist, or when they think a topic web page could become a better resource with more topics added to it. Users have the ability to relate topics with each other, which consequently makes it easier for other users to find similar categories and other related topics of interests. Users who read a topic web page can rate different topics so that the best ones can rise to the top of the web page, if and when a search for the topic has been made.

Users who “create and discover” topics of social interests through the social network system constantly provide a means to directly impact the evolving nature of the collection of web pages based on topics of social interests.

Furthermore, everything in social network system of the present invention is tied back to a user. Each topic web page and its user generated notes associated to each topic have a history associated with them, and each change in their logs is associated with the user who made it. Users can upload pictures, have a list of their favorite topics, and have a short biography describing who they are and what they like. This helps anyone reading topics pages and notes to understand why they should believe what is written, and allows them to take into account the author's perspective on a particular topic of social interest.

### BRIEF DESCRIPTION OF THE FIGURES

FIG. 1 illustrates a simplified block diagram of the interest based social network system.

FIG. 2 is an exemplary illustration of a category of topics in the present invention.

FIG. 3 illustrates the import process for mapping user notes from external social networks into the category of topics in the present invention.

FIG. 4 illustrates the export process for mapping user notes from the category of topics back into external social networks in the present invention.

FIG. 5 illustrates semantic tag types and relationships between topics used within the components of the present invention.

FIG. 6 illustrates four different viewing modes between the timelines of notes, topics of interest, my interests and my social activities in the present invention.

FIG. 7 illustrates a timeline of notes of for all topics of social interests a user is following at time of login in the present invention.

FIG. 8 illustrates a set of topics a user is following at the time of login in the present invention.

FIG. 9 illustrates the notes details for a particular topic at the time of login in the present invention.

FIG. 10 illustrates a set of topic album details for a particular topic at time of login in the present invention.

FIG. 11 illustrates a set of topic photos for a particular topic in the present invention.

FIG. 12 illustrates a set of topic relationships for a particular topic in the present invention.

FIG. 13 illustrates the “my Interest” navigation list in the present invention.

FIG. 14 illustrates the “my social” tab in the present invention in the present invention.

FIG. 15 illustrates how users create a topic in the present invention.

FIG. 16 illustrates how users create a related topic in the present invention.

FIG. 17 illustrates how users create a relationship between topics in the present invention.

FIG. 18 illustrates a user interface for searching capabilities provided within the present invention.

FIG. 19 illustrates a user interface for faceted searching capabilities in the present invention.

FIG. 20 illustrates the process for searching the category of topics through the tag types enriched through user generated tag words in the present invention.

FIG. 21 illustrates a filter box for notes, topics, or search results in the present invention.

FIG. 22 illustrates the system architecture of the present invention.

### DETAILED DESCRIPTION OF THE INVENTION

Core Components of the Interest Based Social Network System

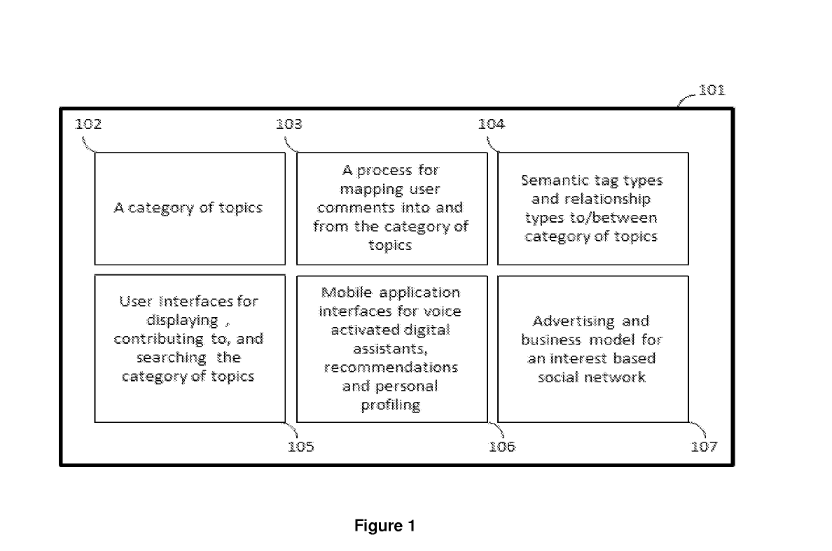

FIG. 1 shows a simplified block diagram of the core components behind the functioning of the interest based social network system of the present invention. The core components 101 include:
a category of topics 102,
a process for mapping user notes into and from external social networks into the category of topics 103,
a set of semantic tag types, and relationship types between topics 104,
a set of user interfaces for displaying, contributing to, and searching the category of topics 105,
a set of mobile application interfaces for voice activated digital assistants, recommendations and personal profiling 106, and
an advertising and business model for an interest based social network 107.

A category of topics 102 provides a hierarchy of topics, each topic being associated to with a plurality of categories and sub-topics.

A process for mapping user notes into and from the category of topics 103 imports user notes generated in external social networks into the category of topics 102, and exports user notes generated in the category of topics 102 back into external social networks.

A set of semantic tag types and relationship types 104 for/between the category and topics 102, enable the addition of semantics to provide sufficient search and display capabilities of topics of social interest.

A set of user interfaces for displaying, contributing to, and searching the category of topics 105 assist the users to select and view desired topics of social interest as well as create and discover new topics of social interests.

A set of mobile application interfaces for voice activated digital assistants, recommendations and personal profiles 106 enable personalized computing as a means to provide a more meaningful search query.

An advertising and business model for an interest based social network 107 allows a direct way to generate income by directing consumers to purchases of products and services related to particular topic of social interest, (e.g. topic of interest=music and direct purchase=songs via Apple iTunes store), and by offering topic web pages to brand management teams in order to facilitate the monitoring of user notes, ratings of concerned topic and associated end user demographics and analytics.

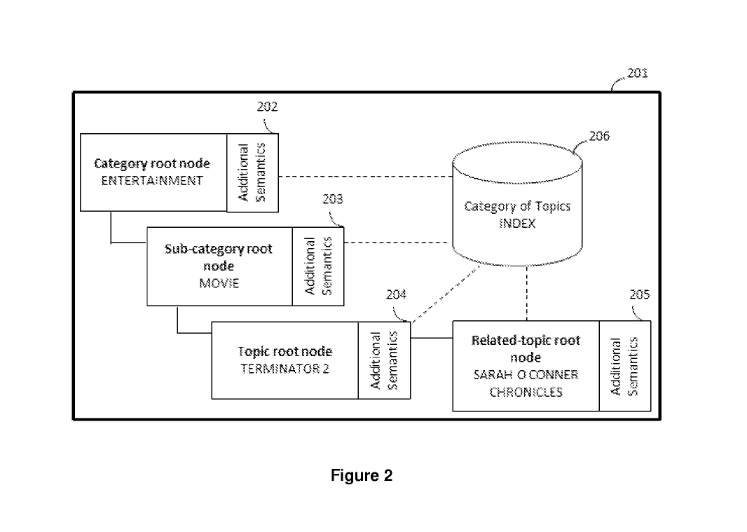

FIG. 2 illustrates a category of topics 201. The category of topics is built in a hierarchical manner, which includes a category root node 202, sub-category root node 203, topic root node 204 and a related-topic root node 205. These root nodes denote specific semantic levels of categorization concerning various topics of social interests, generated both in advance and as a consequence of end user contribution through user interfaces defined in FIG. 1 105. The category of topics 201 is programmed to be updated automatically upon user inputs via the user interface components shown in FIG. 1.

Various tag types and relationships types 104 add additional semantics to the each node (202, 203, 204 and 205) in the category of topics 201, so as to enrich their search and display capabilities. Subsequently, for search and display purposes, each level of categorization can also play the role of a faceted hierarchy, in terms of providing various search and navigation levels in user interfaces 105.

The additional semantics in the form of relevant keywords and tags words (including tag words for photos) for each node (202, 203, 204 and 205) in the category of topics 201 create index entries that are stored in the category of topics index 206.

The categories of topics may be stored in a database structure, or any other type of data repository including ontological models, knowledge base repositories, or flat XML files.

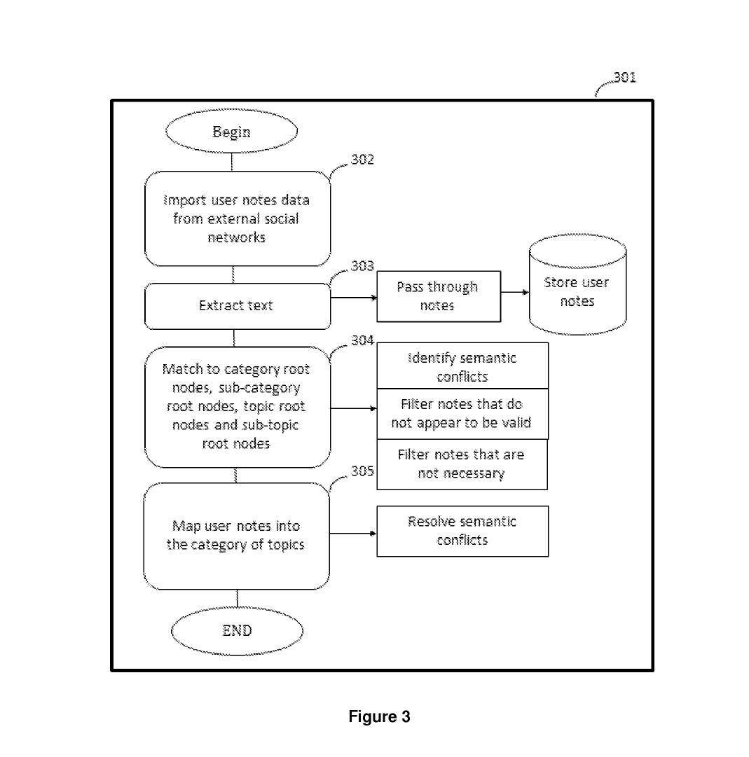

FIG. 3 illustrates the process for importing user notes from external social networks 301, into the category of topics 201 in FIG. 2. The function of the process 301 in FIG. 3 is to examine user notes from external social networks, and create a mapping of those user notes by the category of topics 201 in FIG. 2. The mapping process should be an accurate classification of the contents of the user notes within the range of the category of topics 201 in FIG. 2.

After a user has opted into giving his/her permission to access the user's notes generated in external social networks, the import process in FIG. 3 begins by importing user notes data from external social networks 302. Depending on the nature and type of the external social network from which the user notes are being extracted, there may be several sub-steps involved, such as access control for third party usage, as well as the download and installation of connecting Application Protocol Interfaces (APIs). With respect to some external social networks, the interest based social network website of the present invention may be a registered affiliate application. This allows the automatic authorization of the users, and the automatic authorization and authentication of the interest based social network website of the present invention. Examples of external social networks where the website of the present invention may be a registered affiliate application include Facebook and Twitter. Additionally, for implementation purposes, the present invention uses several methods from the Open Graph API in Facebook, and several methods from the REST API in Twitter. However, the present invention is not limited to these APIs, and may be used with additional methods and APIs to interact with and import text from other external social networks.

In step 303, there are several methods for examining the user notes and extracting the raw text that is to be written to persistent storage. In one embodiment, user notes are examined for data in the form of plain text, and then that text is extracted and used further to determine a topic using a number of algorithms.

Once the user notes data are in plain text format and are stored in persistence storage at 303, step 304 matches a variety of keyword data to category root nodes, sub-category root nodes, topic root nodes and sub-topic root nodes in the category of topics 201 in FIG. 2. These key words can be in the form of words denoted by hash tags as well as a predefined list of tags types (i.e. tag words) 104. The matching of keywords is dependent on a number of factors, including similarity scoring, keywords proximity, ontological reasoning through alignment, integration or merge, and the assistant of natural language processing techniques for semantic understanding. Subsequently, through semantic understanding gained at this stage, notes that generate semantic conflicts are identified and notes that do not appear valid and that are concluded to be unnecessary are filtered out.

The final step 305 is responsible for mapping the user notes into the category of topics 201 in FIG. 2. The precise mapping of user comments into the category of topics is dependent on a number of factors, including the choice of mapping techniques (e.g. SQL mapping, ontological integration and merge etc.), one-to-one mapping versus one-to-many mappings and reasoning mechanisms used for resolving semantic conflicts (if any).

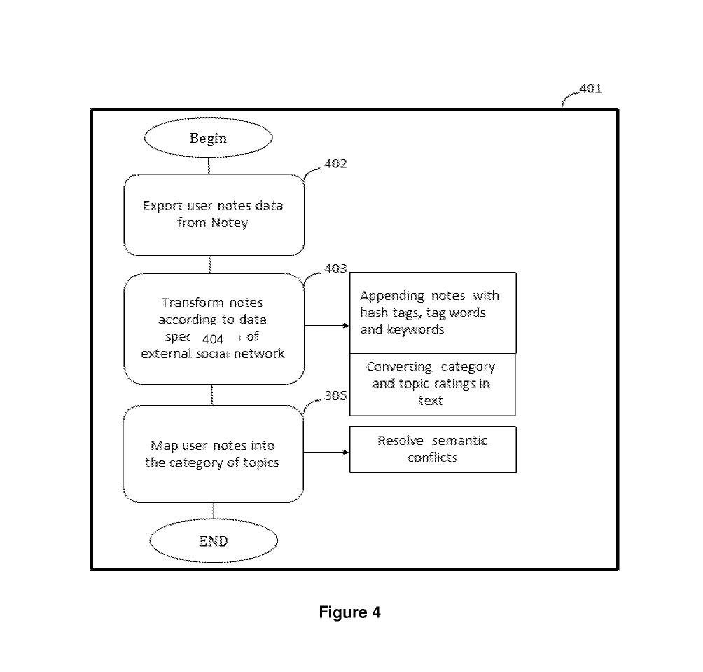

FIG. 4 illustrates the process for exporting user notes from the category of topics 201 in FIG. 2 back into external social networks. The function of the process 401 in FIG. 4 is to examine user notes from the category of topics 201 in FIG. 2, and to create a mapping of those user notes back into external social networks.

After a user has opted into giving his/her permission to allow the user's notes generated in the interest based social network to be mapped back into any other external social network they may prescribe to, the export process 402 in FIG. 4 begins by accessing user notes data from the interest based social network of the present invention.

Once the user notes data from the category of topics 201 are obtained, step 403 transforms the notes according to the relevant data specifications dictated by external social networks. Transformations may involve appending the notes with a hash tags, tag words and keyword descriptions, as well as the converting ratings into text based notes. The exact transformation of notes is dependent on a number of factors, including the type and number of data elements and structures defined in data specifications for external social networks, choice of transforming techniques (e.g. data element mapping, ontological alignment etc.), levels of data granularities and reasoning mechanisms used for resolving semantic conflicts (if any).

Step 404 then maps the user notes back into external social networks, e.g. mapping the user notes back into a Twitter timeline, or Facebook wall. The precise mapping of user notes into external mapping is dependent on a number of factors, which include access control and installation of connecting APIs.

For both the processes 301 and 401 in FIG. 3 and FIG. 4, the user is offered the choice to opt-in/out to giving his/her permission at the time of initial registration. Additionally, users may opt-in/out at any time through their account settings page.

Furthermore, the notes being imported or exported are updated on a periodic basis through general batch processing techniques.

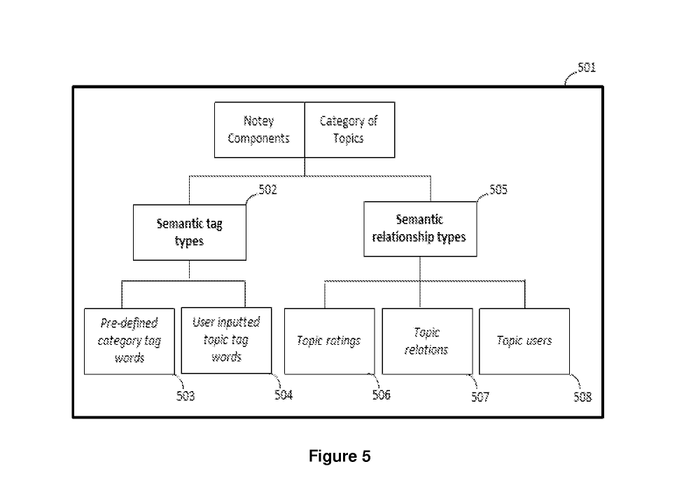

FIG. 5 illustrates the semantic tag types and relationship types between topics 501, used within the components shown in FIG. 1 and by the category of topics shown in FIG. 2.

Semantic tag types and relationship types between topics are at the heart of the search and display functionalities of the present invention. Through various types of tags and relationships, the present invention is able to provide a faceted search and display hierarchy that can be outputted to a number of interfaces within the interest based social network system.

Semantic tag types 502 are of two types: pre-defined category tag words 503 and user inputted topic tag words 504. The pre-defined category tag words 503 refer to tag words that have been pre-enumerated and modeled into the category of topics 201 in FIG. 2, for the sake of describing the category root node 202 and sub-category root node 203 in FIG. 2. The user inputted topic tag words 504 refers tag words that have been inputted by users 504 into the category of topics 201 in FIG. 2 as a consequence of user contribution. The user inputted topic tag words 504 are significantly different from the pre-defined tag words 503 because they describe the topic root node 204 and related-topic root node 205 in FIG. 2.

Semantic relationships types 505 are of three types: topic rating 506, topic relation 507 and topic users 508. The topic rating 506 refers to the relationship between a topic root node 204 and its rating (additional semantics) in FIG. 2. The topic relation 507 refers to the relationship between a topic root node 204 and a related topic root node 205 in FIG. 2. The topic user 508 refers to the relationship between users of the topic, their age, location and sex. All relationship types are generated as a consequence of user inputs.

The direct association between the various levels of the category of topics 201 in FIG. 2, including tag/relationship types and additional semantics, provide an enriched faceted hierarchy. As a consequence, a broader and deeper choice of ranking search results across a number of dimensions can be generated. Some dimensions corresponding directly to each tag type associated to the category root node 202, sub-category root node 203, topic root node 204 and a related-topic root node 205 in FIG. 2, and other dimensions corresponding directly to either topic rating, and user information such as age, sex, and location.

Furthermore, the tag and relationship type set-up is not restricted and limited to the above-mentioned five types. The present invention may accommodate ‘n’ of types, depending on the (i) ranking requirements, (ii) faceted views, and (iii) the levels of data granularity extension points in the category of topic 201 in FIG. 2. Furthermore, tag words stored in a database may easily be replaced with the notion of annotations and ontological rules stored in ontologies, as well as a graph based database in object orientation.

The present invention includes user interfaces, which are the primary means of interacting with, and contributing to the interest based social network. Distinct user interfaces of the present invention provide a medium for displaying components of the interest based social network, contributing towards components of the interest based social network, and searching components of the interest based social network.

Additionally, other user interfaces allow users to join various existing topics of social interests, select friends with similar social interests, select and share topic lists with friends, view the web pages of friends within their social network, and access their shared media, to search by topic or tag words, and to display updates made by the user or user's friend. The user interfaces provide a means to display notes and photographs related to topics of social interest. Examples of all user interfaces can be found in the Appendix at the end of this document.

A number of user interface components can be viewed as already in use by other social networks, however, the style or arrangement of the elements of the present invention's website user interfaces are specific to the core components outlined in FIG. 1.

The set of user interfaces developed for displaying components of the present invention surrounds the area of displaying a user's topics of social interest. This includes displaying (i) an up-and to-date timeline of notes generated for all the topics of social interests a user is following, (ii) the user's personal choice of topics he/she is following within the interest based social network and (iii) an up-and to-date timeline of social activities/updates generated by the user and his/her friends network. Specifically, the interfaces concern the ability of a user to switch to and from different viewing modes between the timeline of notes, topics of interests and social activities.

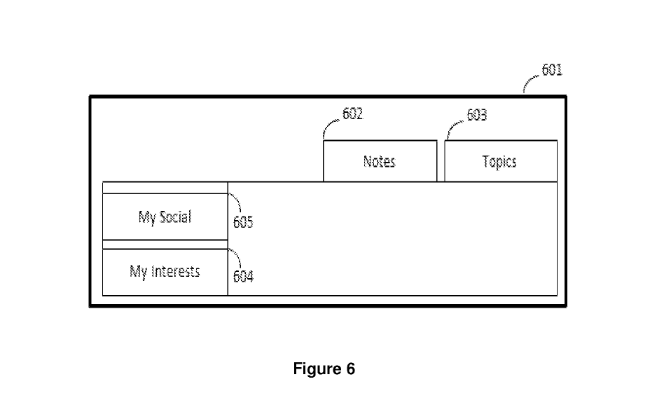

FIG. 6 illustrates four different viewing modes 601 between the timeline of notes, topics of interests and social activities. The timeline of notes 602 tab will display a friends list of notes generated according to topics of social interest. The topics tab 603 will display a set of topics the user is following at time of login. The “my interests” list display box 604 will display lists of topics the user has created, and categories of topics the user has pre-defined as part of his/her preference settings. The “my social” tab 605 will display the timeline of social activities/updates for the user and friends he/she is following in his/her network.

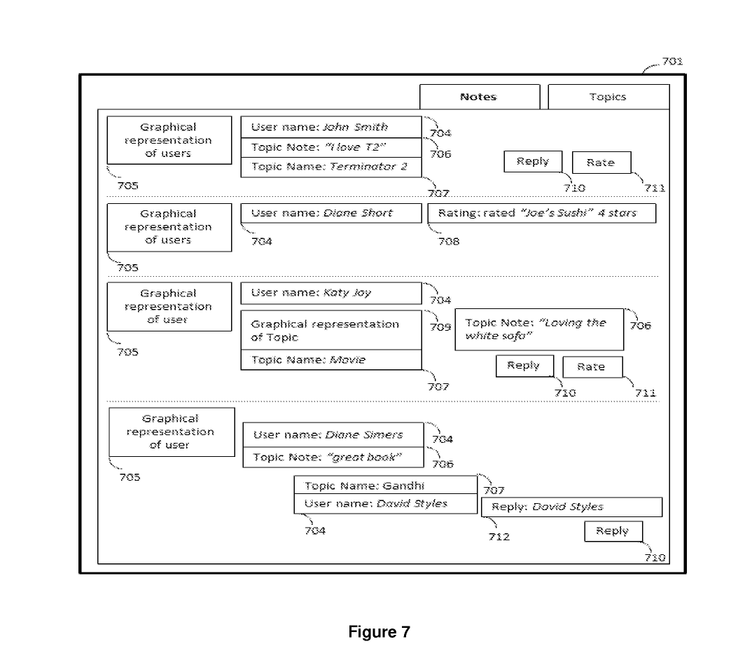

FIG. 7 illustrates a timeline of notes 701 for all the topics of social interests the user is following. The timeline of notes 701 may be selected by the user via a timeline of notes tab 602 in FIG. 6. The timeline of notes 701 vertically displays the names of the all other users 704 following the same topics of social interest, and also displays their associated graphical representations (i.e. photos) 705. The notes 706 generated by the other users are also displayed according to the topic name 707 they belong to. For example, ‘John Smith’ 704 generated the note “I love T2” 706 as part of topic ‘Terminator 2’ 707. The notes generated and displayed in the timeline of notes 701 may be in a text comment 706, rating 708 or photographic 709 format. Notes may also be in the format of video or social media.

Reply 710 and rating 711 options are also associated with the timeline of notes 701. The reply option 710 allows the user to type a reply 712 to the note being displayed in the timeline of notes 701. Upon submitting the reply 712, the reply is added as a note to the timeline of notes 701 in a text comment format 708, as well as the timeline of social activities/updates.

The rating option 711 allows the user to rate a particular topic within the timeline of notes 701. Upon submitting a rating 711, the rating is added as a note to the timeline of notes 701 in a text comment format 708, as well as the timeline of social activities/updates.

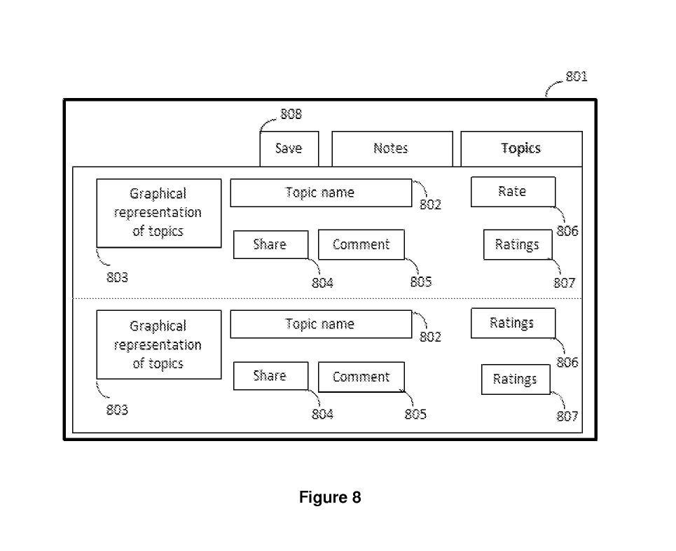

FIG. 8 illustrates a set of topics 801 the user is following at time of login. The set of topics may be selected via the topic tab 603 in FIG. 6. A set of topics 801 displays the names of the topics 802, associated graphical representations of the topics (i.e. photos) 803, and the number of ratings for the topic itself 806. The different topics in the set of topics may be displayed in a vertical format as shown in FIG. 8, with each subsequent topic displayed below the previous topic.

Share 804, comment 805, rating 806 and save 808 options and the number of ratings per topic 807 are also displayed with the set of topics 801. The share option 804, allows the user to share a particular topic of interest displayed in the set of topics 801. Upon sharing the topic 804, the user is prompted to choose between sharing the topic within the either interest based social network of the present invention, external social networks such as Facebook and Twitter, or both. The topic is added to the timeline of notes 701 in a text comment format 708 as shown in FIG. 7.

The comment option 805 allows the user to make a comment on a particular topic of interest displayed in the set of topics 801. Upon commenting on a topic 805, the user is prompted to choose between publishing the comment within either the interest based social network of the present invention, external social networks such as Facebook and Twitter, or both. The comment is added as a note to the timeline of notes 701 in FIG. 7, as well as the timeline of social activities/updates.

The rating option 706 allows the user to rate a particular topic within the set of topics 701. Upon submitting a rating 706, the user is prompted to choose between publishing the rating of the topic within either the interest based social network of the present invention, external social networks such as Facebook and Twitter, or both. The rating is added as a note to the timeline of notes 701 in a text comment format 708 in FIG. 7, as well as the timeline of social activities/updates.

The save option 808 allows the user to select one or more topics in order to save topics lists in the “my interest” list display box 604 in FIG. 6. Users are able to select and save one or more topics, and give the list a title of their own choice. The next time that the user logs in, the new list will be added to the “my interest” list display box 604 in FIG. 6.

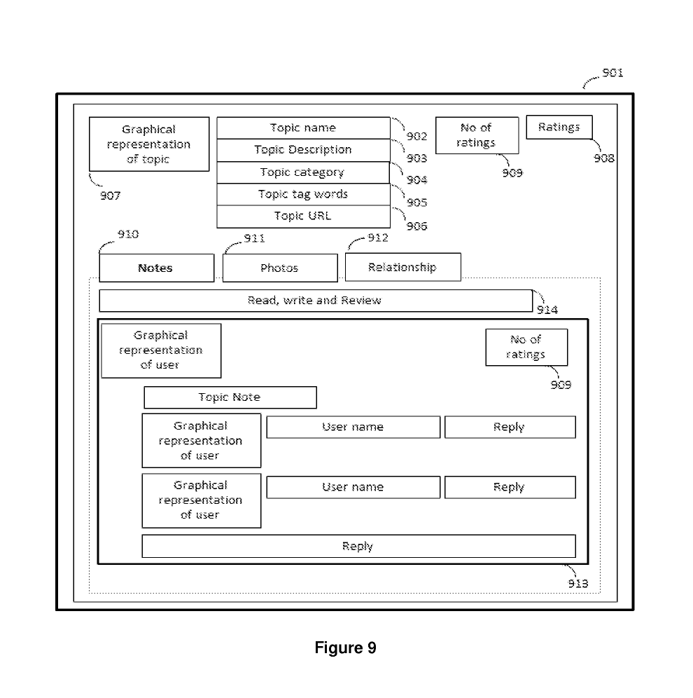

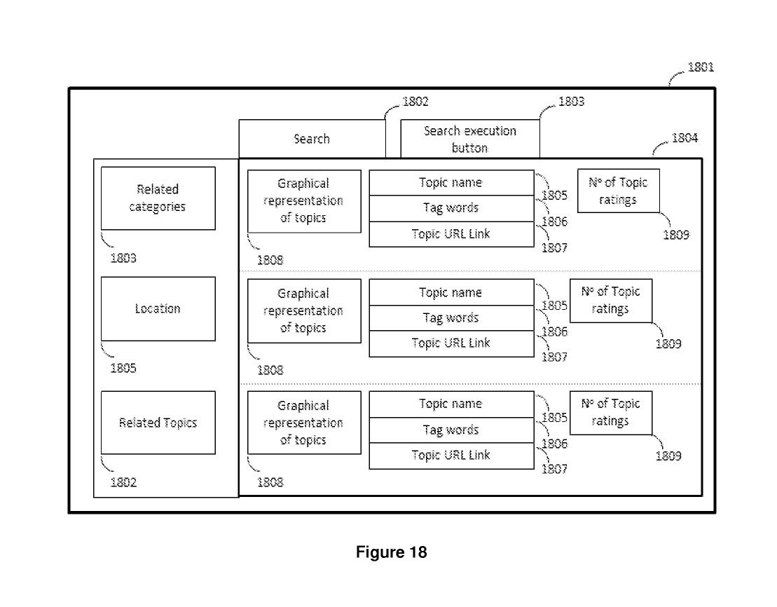

FIG. 9 illustrates the details for a particular topic the user is following at time of login 901. The topic details 901 may be selected by choosing a particular topic from the set of topics 801 in FIG. 8. The topic details 901 may also be selected by choosing a particular topic 1802 as a consequence of a search 1802 in FIG. 18.

The topic details 901 displays the name of the topic 902, topic description (which includes location and telephone number, if any) 903, the topic category 904 corresponding to 203 in FIG. 2, the tag words 905 associated to the category of topics 203 in FIG. 2, the URL to the topic webpage (if any) 906, and associated graphical representation of the topic (i.e. photo) 907.

In addition, a rating option 908 and the number of ratings for the topic itself 909 are also displayed in the topic details 901. The rating option 908, allows the user to rate a particular topic within the topic details 901. Upon submitting a rating 908, the user is prompted to choose between publishing the rating of the topic within either the interest based social network of the present invention, external social networks such as Facebook and Twitter, or both. The rating is added as a note to the timeline of notes 701 in a text comment format 708 in FIG. 7.

Furthermore, different detail modes for the topic details 901 may be selected by the users via a notes tab 910. A photos tab 911 and a relationship tab 912 may also be selected. The photos tab 911 will display a set of albums, including the photos that have been uploaded by users as part of the specific topic. The relationships tab 912 will display a set of relationships that have been defined as part of the specific topic.

Within the notes tab 910, a timeline of notes 913 is displayed vertically, similar to that of the timeline of notes 701 in FIG. 7. However, in the case of the notes tab in the topic details page, the timeline of notes 913 is specific to a single topic. The timeline of notes 913 also provides a comment option 914. The comment option 914 allows the user to make a comment on the topic displayed in the topic details 901. Upon commenting on a topic, the user is prompted to choose between publishing the comment within either the interest based social network of the present invention, external social networks such as Facebook and Twitter, or both. The comment is added as a note to the timeline of notes 701 in FIG. 7.

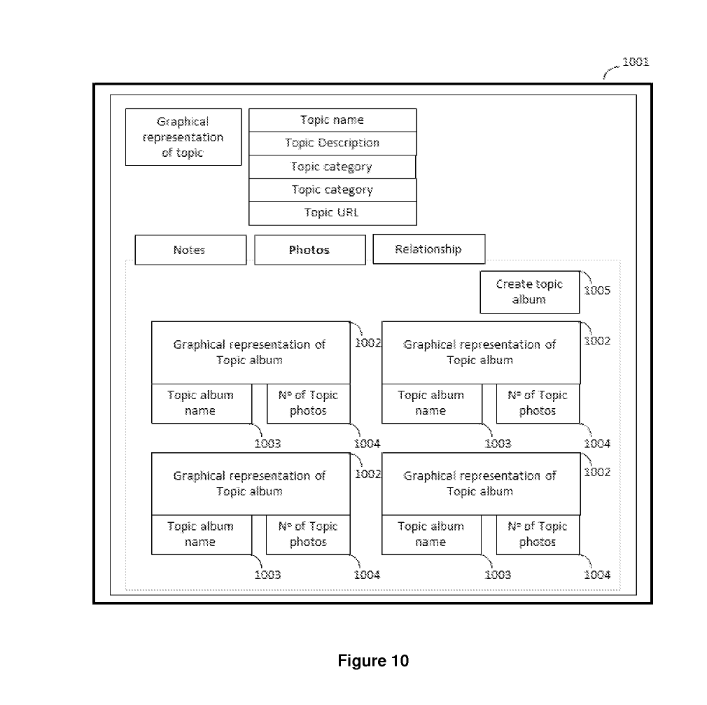

FIG. 10 illustrates a set of topic albums 1001 that have been uploaded by users as part of the specific topic details 901 in FIG. 9. The set of topic albums, including their photos, may be selected via the photo tab 911 in FIG. 9. Each individual topic album 1002 is displayed vertically. The topic album name 1003 and the number of photos the topic album contains 1004 are also displayed.

The set of topic albums 1001 also provides a create album option 1005. The create album option 1005 allows the user to create a topic album by uploading a number of photos related to the topic details 901 in FIG. 9. Upon creating an album, the user is prompted to specify the topic album name (which may be set to being public to all users), location of where the topic photo is being uploaded from, topic photo tags (if any), and topic photo comment (if any). The user is also given the choice of sharing the topic album with the public, with friends, or of remaining anonymous. The addition of a new topic album is added as a note to the timeline of notes 701 in FIG. 7.

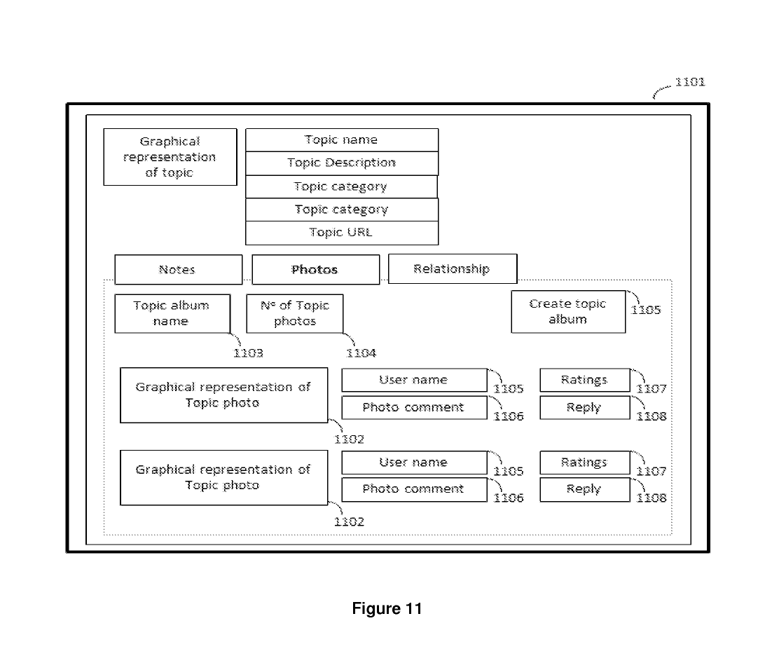

FIG. 11 illustrates the set of topic photos 1101 that have been uploaded by users as part of the specific topic details 901 in FIG. 9. The set of topic albums, including their photos may be selected via the photo tab 912 in FIG. 9. Each individual topic album 1102 is displayed vertically. The topic album name 1103 and the number of photos the topic album contains 1104 are also displayed.

The set of topic photos 1101 also provides the create album option 1105. The create album option 1105 allows the user to create a topic album by uploading a number of photos related to the topic details 1101 in FIG. 7. Upon creating an album, the user is prompted to specify the topic album name (which may be set to being public to all users), location of where the topic photo is being uploaded from, topic photo tags (if any), and topic photo comment (if any). The user is also given the choice of sharing the topic album with the public, with friends, or remaining anonymous. The addition of a new topic album is added as a note to the timeline of notes 701 in FIG. 7.

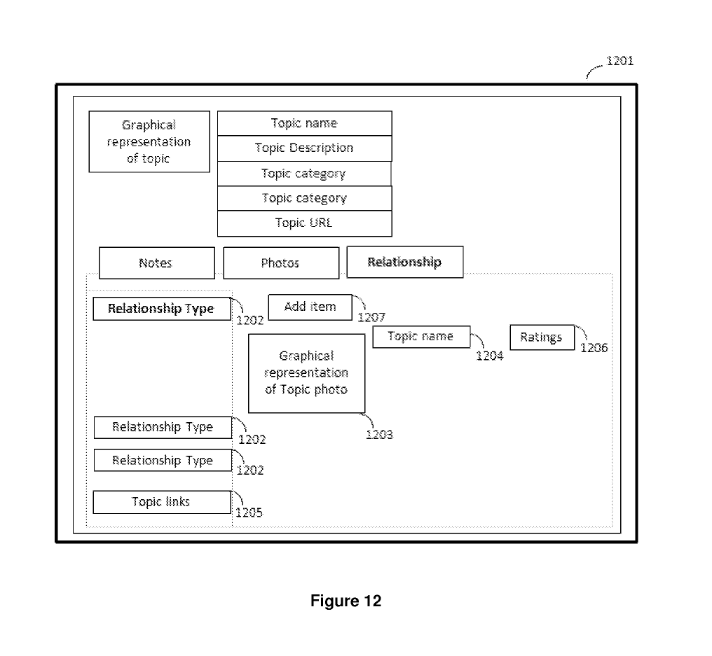

FIG. 12 illustrates the topic relationship details 1201 between the specific topic details 901 in FIG. 9, and other topics in the category of topics 201 in FIG. 2. The topic relationship details may be selected via the relationships tab 912 in FIG. 9. Each individual relationship type 1202 is displayed vertically. Depending on which relationship type is selected by the user for display, the related graphical representation of topics 1203 and topic names 1204 are displayed. In addition, the topic URL links 1205 for the specific topic details 901 in FIG. 9 are displayed.

A rating option 1206 and a add item option 1207 are also displayed in the topic relationship details 1201. The rating option 1206, allows the user to rate the concerned related topic within the relationship details 1201. Upon submitting a rating, the user is prompted to choose between publishing the rating of the topic within either the interest based social network of the present invention, external social networks such as Facebook and Twitter, or both. The rating is added as a note to the timeline of notes 701 in a text comment format 708 in FIG. 7.

The add item option 1207 allows the user to select a relationship type 1202, and add a topic name as an item for that particular relationship type, i.e. to add other topics related to the specific topic details 801 in FIG. 8, through the relationship type 1202. Upon adding the topic name, the user is prompted to specify the category name to which the related topic name belongs, and to save the related topic name. The addition of the new item (i.e. topic name) in a particular relationship type 1202 is added to the display the next time a user views the specific topic relationship details 1201.

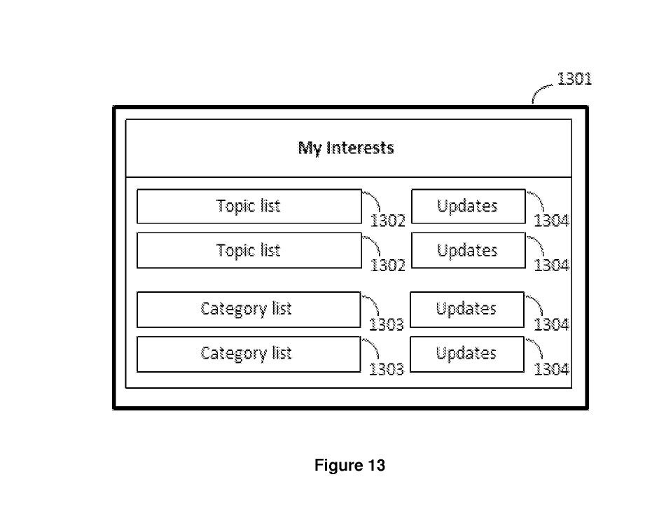

FIG. 13 illustrates the “my interest” navigation list 1301. The “my interest” navigation list is a fixed display view that is constantly available to the user at the time of login. The “my interest” navigation list 1301 displays the names of each topic list 1302 the user has created, and the names of each category list 1303 the user has set as the personal preference at time of registration. The “my interest” navigation list also displays any updates 1304 that may be of interest to the user.

The topic lists 1302 may contain a number of topics, which may not necessarily belong to the same category node 202, sub-category node 203, or related-topic node 204 in FIG. 2. The topic lists 1302 are specific to what topics the user has decided to save in 808 in FIG. 8. Upon selecting a topic list 1302, the user is offered a timeline of notes 701 as shown in FIG. 7. However, the complete set of notes displayed will be applicable to the exact number of topics shared in the topic list.

The category lists 1303 may contain a number of categories belonging to the category node 202 in FIG. 2. The category lists 1303 are specific to what interest preference the user has given when registering with the interest based social network of the present invention. Upon selecting a category list 1303, the user is offered a timeline of notes 701 as shown in FIG. 7. However, the complete set of notes displayed will be applicable to all the topics associated to the category list.

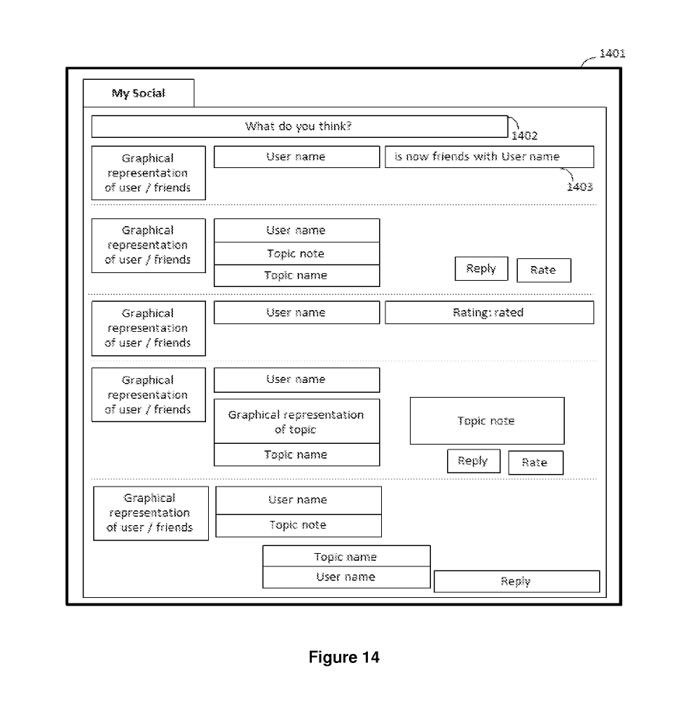

FIG. 14 illustrates a timeline of social activities/updates 1401 for a user and his/her friends in his/her social network. The timeline of social activities/updates 1401 may be selected by the users via the “my social” tab 605 in FIG. 6.

The timeline of social activities 1401 displays an option to allow the user to type a note 1402 in the timeline of social activities/updates. Upon submitting the note 1402, the note is added as a note to the timeline of notes 701 in a text comment format 708 in FIG. 7, as well as the time of social activities/updates 1401.

The timeline of social activities 1401 also vertically displays names of the user or his/her friends from his/her social network, and their associated list of social activities/updates. The social activities/updates include the notes, rating and pictures they have created/uploaded, similar to that of the timeline of notes 701 in FIG. 7. However, the difference between the timeline of social activities/updates 1401 and time of notes 701 in FIG. 7 is that the timeline of social activities/updates displays all the activities particular to the user, or the user's friends in his/her social network, rather than a display according to the users topics of social interest. Furthermore, specific updates regarding the be-friending of other users on the network 1403 will also be displayed.

The set of user interfaces developed for contributing towards components of the interest based social network specifically allow user contribution to other components by making new notes, adding topics and related topics, and defining new relationships between topics. Such contributions enrich the category of topics 201 in FIG. 2, consequently providing better and broader topics of social interest for search within the interest based social network. The category of topics 201 is programmed to be updated automatically upon user inputs via the user interfaces 104 in FIG. 1.

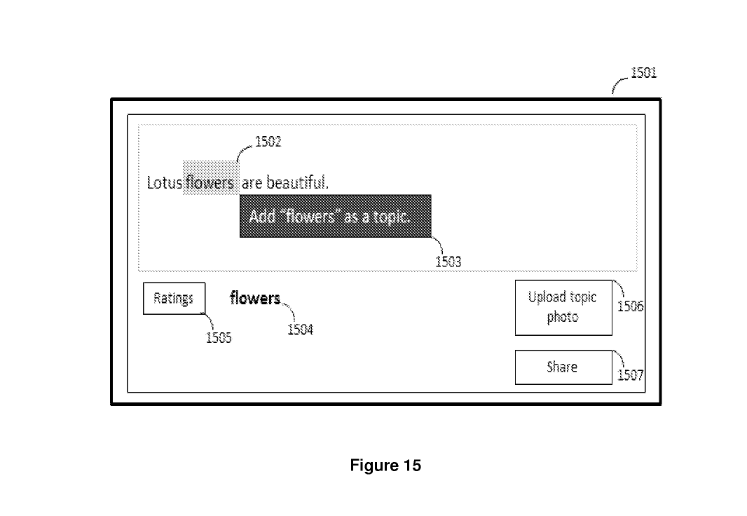

FIG. 15 illustrates how users create a topic 1501. The option of creating a topic 1501 is automatically offered to the user when he/she makes a comment 915 in FIG. 9, or when he/she makes a note 1402 in FIG. 14. Upon highlighting a key word/phrase 1502 in the comment 915 in FIG. 9 or note 1402 in FIG. 14, the option to add the key word/phrase as a topic 1503 is displayed.

Upon selecting the add topic option 1503, the system checks to see if a topic name that is the same as the key word/phrase highlighted already exists. If the topic name does exist, then the keyword/phrase is displayed 1504. The user is given the options to add a rating for the topic 1505, upload an associated picture if any 1506, and choose to share the topic, its rating and photo with all users, friends of the user only, or nobody at all 1507.

If the topic does not exist, a new topic is created and the user is prompted to specify the description of the topic, select the category to which the topic belongs, rate the topic, add any descriptive tag words, and save the topic. The tag words, if any, are stored and associated with the new topic for future use.

Additionally, if the user highlights the same key word/phrase again, an option to remove the keyword/phrase as a topic will be displayed.

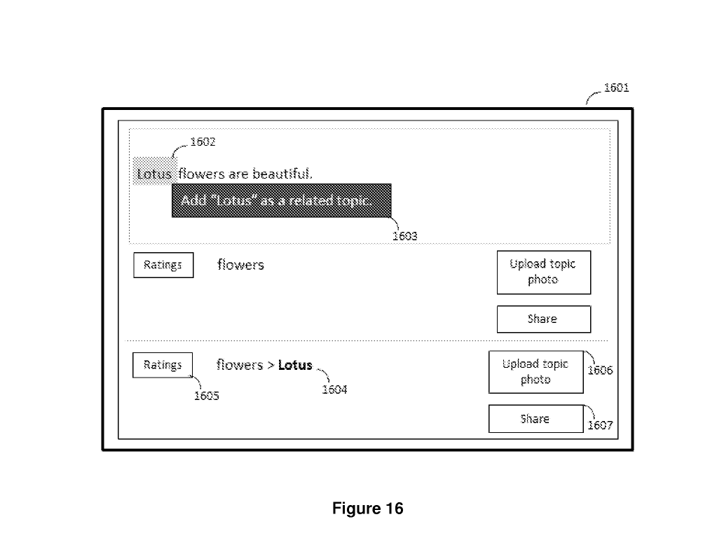

FIG. 16 illustrates how users create a related topic 1601 to the topic created 1501 in FIG. 15. The option of creating a related topic 1601 is automatically offered, once the user has decided to create a topic 1501 in FIG. 15 through making a comment 915 in FIG. 9, or when making a note 1402 in FIG. 14. Upon highlighting a key word/phrase 1502 in the comment 915 in FIG. 9 or note 1402 in FIG. 14, the option to add the key word/phrase as a related topic 1603 is displayed.

Upon selecting the add related topic option 1603, the system checks to see if a topic name that is same as the key word/phrase highlighted already exists. If the topic name does exist, then the keyword/phrase is displayed 1604. The user is given the options to add a rating for the topic 1605, upload an associated picture if any 1606, and choose to share the related topic, its rating and photo with all users, friends of the user only, or nobody at all 1607.

If the related topic does not exist, a new topic is created and the user is prompted to specify the description of the topic, select the category to which the topic belongs, rate the topic, add any descriptive tag words, and save the topic. The tag words, if any are stored and associated with the new topic for future use.

Additionally, if the user highlights the same key word/phrase again, an option to remove the keyword/phrase as a related topic will be displayed.

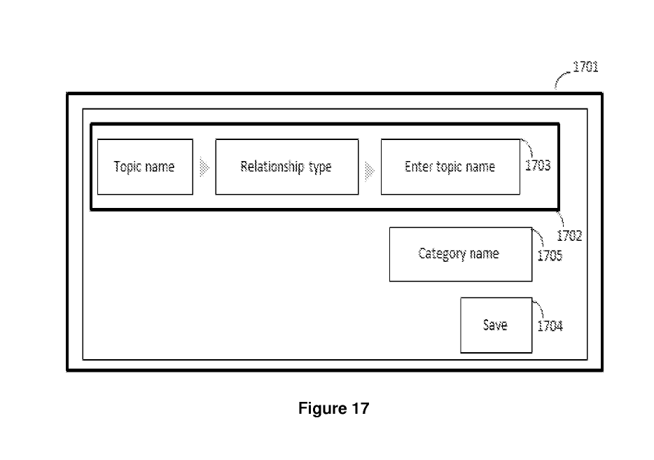

FIG. 17 illustrates how users would create a relationship between topics 1701. The option of creating a relationship between topics 1701 may be selected through the option of adding an item 907 in FIG. 9. Additionally, upon selecting a relationship type 1202 in FIG. 12, the option to add the topic name is displayed 1702.

Upon entering the topic name 1703, an auto-complete list of topic names are offered to the user. If the topic name exists, and a selection of the topic name is made, then the user is prompted to save the relationship 1704. The existence of a topic name is dependent on the category to which the original topic and relationship type belongs. If the topic name does not exist within the auto-complete list, the user is prompted to create a new topic, and to choose a category to which the topic name belongs to 1705. The user ends by to saving the relationship 1704.

The set of user interfaces developed for searching components of the interest based social network specifically allows users to search through the category of topics 201 in FIG. 2. Users are capable of entering specific search terms, similar to searching performed using conventional internet based search engines. Each level of categorization in the category of topics 201 in FIG. 2 also plays the role of a faceted hierarchy, providing the notion of searching various search and navigation levels based on either a broad or narrow set of topics of social interest. Consequently, this freedom in search allows users to explore through social topics of interest by deconstructing categories of topics into specific topic and related topic searches.

When users use the search facility to find topics within the category of topics 201 in FIG. 2, the search mechanism conducts two phases of processing. The first phase involves interpreting and analyzing the user's input so that the topics of social interest that the user desires can be identified. The second phase involves collecting and ranking the results.

FIG. 18 is a user interface illustrating searching capabilities 1801 that is provided within the interest based social network of the present invention. The user interface 1801 includes searching options for a user to find specific topics of social interests, as well as a text box 1802 for user inputs (i.e. search criteria), and a search execution button 1803 for initiating the search. More specifically, a user may input the desired search criteria in the text box 1802 in the form of a key word, a hash tag or a combination of both, and select the search execution button 1803.

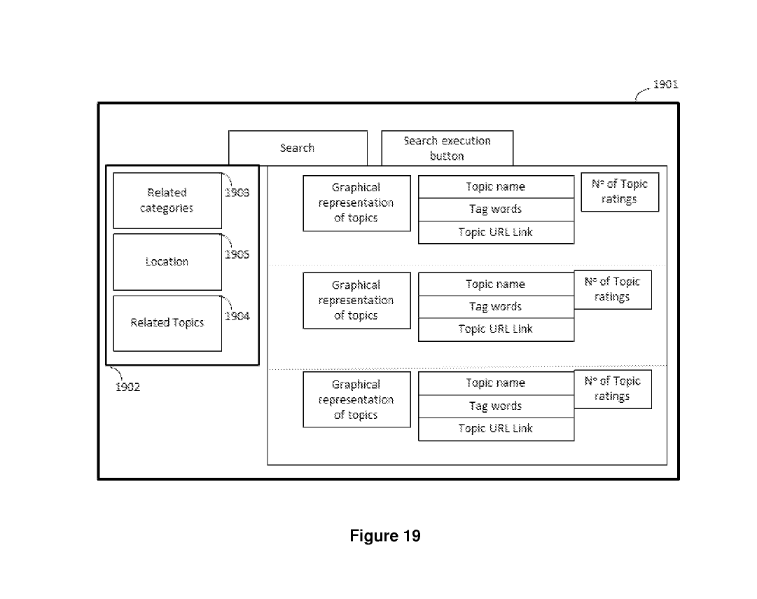

In response to receiving this search request, the process shown in FIG. 19 1901 is triggered, which sends the user inputs of the search request to the internal search engine website server of the present invention.

The user inputs are then further compared to tag types associated with the topics of categories defined in FIG. 2. In response to locating one or more matching categories of topics, the search engine website server can return search results 1804 to the user interface 1801 shown in FIG. 18.

The search results 1804 displays the name of the topic 1805, the tag words 1806 associated to the category of topics in FIG. 2, the URL to the topic webpage (if any) 1807, any associated graphical representations of the topic (i.e. photo) 1808, and the number of ratings given for each topic 1809. The user may select one of the search results to access the desired topic web pages.

FIG. 19 illustrates an example of faceted searching capabilities 1901. The faceted searching capabilities includes hierarchical search navigation 1903 based on the search results as a consequence of ranking topics at various levels of facets as part of the initial search criteria 1802 in FIG. 18.

The first level faceted search hierarchy 1903 includes ranking search results according to each root category 202 in the category of topics 201 in FIG. 2, utilizing the pre-defined category tag words 503 in FIG. 5.

The second level faceted search hierarchy 1904 includes ranking search results according to each topic root node 204 and related topic root node 205 in the sub-category 203 in the category of topics 201 in FIG. 2, utilizing the user inputted topic tag words 504 in FIG. 5.

The third level faceted search hierarchy 1905 includes ranking search results according to the location of the users, so as to provide a topic root node 204 and related topic root node 205 in the sub-category 203 in the category of topics 201 in FIG. 2, utilizing the topic user relation 508 in FIG. 5 related specifically to the location of users.

By allowing users to refine their searches to specific facets, the search capabilities allow the users to locate relevant and similar topics of social interest. This allows users to achieve more enriched and personally directed search results.

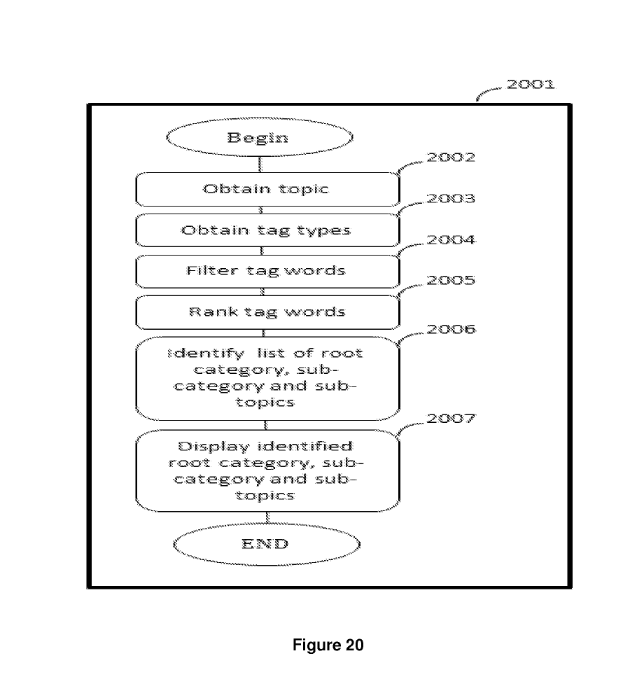

FIG. 20 shows a process for searching 2001 the category of topics 201 in FIG. 2, when a request for search is triggered through the search criteria as a consequence of user inputs and the selection of search execution button 1803 in the user interface 1801 in FIG. 18 above. The search process in FIG. 20 may also be used if and when a user selects topics of interests from a plurality of categories of topics pre-displayed through the faceted search hierarchy 1903 in FIG. 19.

The process in FIG. 20 utilizes existing tag types and relationship types in FIG. 5 that have either been pre-enumerated 503 as shown in FIG. 5, or that have been generated through user inputs as shown in FIGS. 15 and 16. These existing tag types are associated with tag types stored in the category of topic 201 in FIG. 2.

For example, the process in FIG. 20 begins with obtaining “Terminator 2” as a category of topic (step 2002). In this instance “Terminator 2” serves as a topic root node, but may also refer to a category root node, sub-category root node or related-topic root node.

At step 2003, tag words related to “Terminator 2” are identified and extracted from data repositories of the present invention. These repositories may be databases, ontological models or flat files. The tag words may include any number of user generated tag words related to the topic, and predefined tag words describing the category to which “Terminator 2” belongs. Tag words may also be obtained from other external web data repositories (e.g. DBPedia, Wikipedia, and Freebase), in order to provide a deeper search capability. The present invention may also use a number of data repositories to extract the tag words related to tag types associated to each category of topics in FIG. 2 in order to obtain more a balanced result. The tag words from web data repositories would be extracted via a website's API or through a web crawling agent. Furthermore, some web data repositories may provide the tag words through appropriate meta-data, whilst other data repositories may provide textual descriptions, in which case natural language processing techniques will be applied.

A list of tag words is obtained by performing step 2003. Examples of the tag words obtained for the topic “Terminator 2” are “action, james cameron, sci-fi, etc.” Typically, the list of tag words obtained would be dependent on the tag types they correspond to and may result in extracting the exact match to “n” number of tag words as well as “m” number of topics.

In certain circumstances, the tag words may also contain irrelevant tag words. Therefore, at step 2004, the tag words obtained are filtered to remove irrelevant tag words from the tag word list. Natural language process techniques may be applied at this stage.

At step 2005, after any filtering has been performed and depending on whether the search results are being routed back to the user interface 1801 in FIG. 18 or the faceted search hierarchy 1903 in FIG. 19, the appropriate rank is assigned to each tag word. All tag words with a rank lower than a predetermined threshold value are eliminated from display.

At step 2006, the category root node 202, sub-category root node 203, topic root node 204 and a related topic root node 205 in FIG. 2 are identified from the tag words with a rank above a predetermined threshold value in step 2005.

At step 2007, each identified category root node 202, sub-category root node 203, topic root node 204 and a related topic root node 205 in FIG. 2 are displayed accordingly in the user interface 1801 in FIG. 18 or the faceted search hierarchy 1903 in FIG. 19.

At any time after login, the user is able to perform additional filtering to:
timeline of notes 701 in FIG. 7,
set of topics 801 in FIG. 8,
timeline of social activities/updates 1401 in FIG. 14, and
any search results generated as a result of triggering a search through the user interface 1801 in FIG. 18, or the faceted search hierarchy 1903 in FIG. 19.

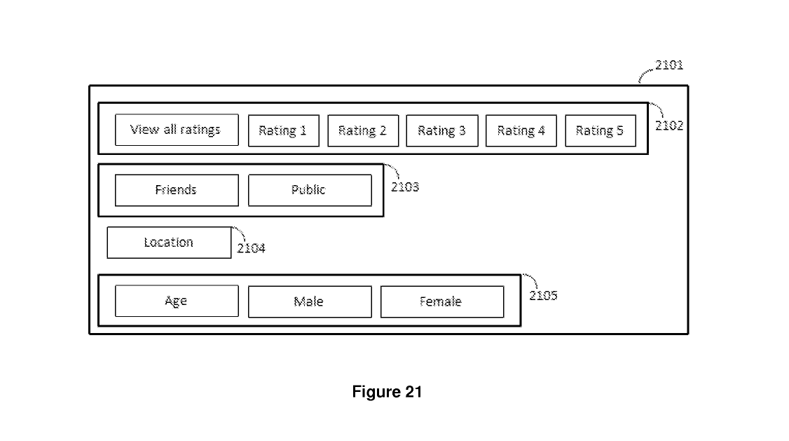

FIG. 21 illustrates the filter box for notes, topics or search results 2101. The filter box 2101 is a fixed display view that is constantly available to the user at the time login.

The filter box 2101 displays the option to filter according to a particular rating for a topic 2102, and the option 2103 to select topic notes according to notes created by the user's friends or public users registered in the interest based social network. The default timeline is derived from the total number of users, however using the filtering box 2101, users have the ability to change the timeline of notes to their friends list only.

The filter box 2101 also offers the user the choice to filter according to the location of the user 2104 and the option to choose demographic details 2105 such as the age and sex of the users whom have contributed to the notes and topics.

Upon selecting any of the filtering options in the filter box, the search process in FIG. 20 interprets the user selection as a new search criterion. Depending on which filter option is selected, the appropriate rank is assigned to each tag word, where the rank has been specifically designed to support filtering functions.

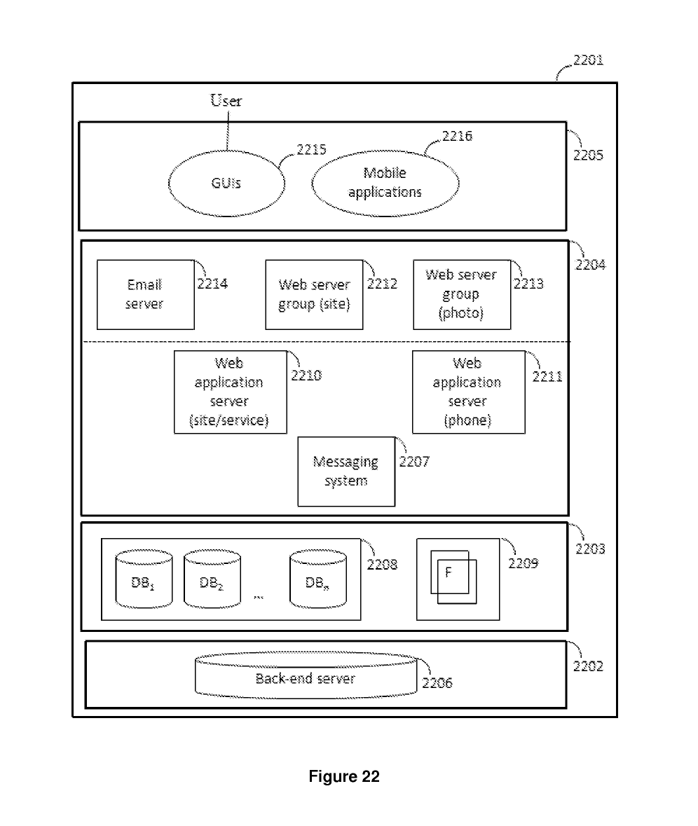

FIG. 22 illustrates an example system architecture 2201 that can be used to support the methods and processes for generating and accommodating the interest based social network.

The system architecture comprises a back-end layer 2202, a persistent layer 2203, a logic layer 2204, and a communication layer 2205.

The back-end layer 2202 hosts the back-end server 2206 that is responsible for handling several functions. These functions handled by the back-end server may involve (i) the execution of batch processing, (ii) the service of a category of topics index (i.e. index server for search purposes), and (iii) the automatic monitoring and updating of services provided by the interest based social network to users. In particular, the execution of batch processing may concern the update of the notes being imported or exported from external social networks, as well as the update of notifications, activities and friend requests generated within the interest based social network (triggered by events generated in the messaging system 2207).

The persistent layer 2203 hosts all the data the interest based social network system needs and generates as a consequence of its functioning. Persistent storage may be in the format of databases 2208, file systems 2209 or any other format such as ontologies, media servers, or web data repositories. Databases may be in the form of either an index with search and scalability facilities for the back-end server 2206, or a traditional relational table for storing user account login information, categories of topics (including category, sub categories, related topics and relationship types between topics), profile information, privacy rules, social network user associations (e.g., friend information), etc.

The logic layer 2204 hosts the several components that control the flow of data, computations and logic to and from GUI/mobile applications and the persistent layer and back-end layers. In particular, the messaging system 2207 works with the back-end server 2206 to manage all the communication from the preceding layers and the back-end layer. The web application server (site/server) 2210 and the web application server (phone) 2211 are responsible for managing all the logic, data and computations concerning user requests. The core of the web application server (site/server) 2210 and the web application server (phone) 2211 functioning is the core business logic behind coordinating applications, processing any commands, decision making, and data manipulation and transformation.

The logic layer 2204 also hosts the web server group (site) 2212 and the web server groups (photo) 2213 are responsible for managing all the web logic concerning user requests/tasks, including any required web routing/networking. This may involve translating the user requests/tasks to a format the logic layer 2204 can understand.

The email server group 2214 is responsible for coordinating and emails incoming into, or outgoing from the system.

The communication layer 2205 hosts the main communication channels in the form of GUIs 2215 as described previously, and mobile applications 2216. The communication layer 2205 is mainly responsible for presentation logic such as translating user tasks and search results into a format the user can understand. Subsequently, the user accesses the system of the present invention by logging on to their respective user accounts stored in a number of databases 2208 for the interest based social network.

The user may login to the user account by any device connected to the internet or which provides a user with access to an online website. Examples of devices a user may connect to the interest based social network of the present invention with include computers, laptops, tablets, smartphones, cell phones, or PDAs.

The system architecture 2201 accommodates an n-tier application architecture.

1. A method for providing a collection of web pages in an interest based social network based on interest topic categories, said method comprising:
providing a web-based application which allows user to log into and interact with an interest based social network,
providing a category of topics stored in a database structure, said category of topics being displayed to said user in the form of an evolving collection of webpages;
mapping user generated comments into and from the category of topics, wherein the user generated comments are imported from external social networks and webpages and generated directly in interest based social network, and wherein user generated comments are exported from the interest based social network to external social networks and webpages;
creating semantic tag types and relationship types for and between the categories of topics, wherein user interfaces provide search and display options for said semantic tag types and relationship types; and
providing user interfaces for displaying, contributing to, and searching the category of topics.

2. An interest based social network system comprising:
a web-based application program providing users access to the interest based social network system;
a database structure containing a category of topics, wherein each topic is stored in a topic webpage;
a back-end layer comprising a server, wherein the server executes processing to map user generated comments into and from the category of topics, wherein the user generated comments are imported from external social networks and webpages and generated directly in interest based social network, and wherein user generated comments are exported from the interest based social network to external social networks and webpages;
a set of user interfaces for displaying, contributing to, and searching the category of topics; and
a communication layer communicating between the application program, database structure, server, and user interfaces.
